(19) United States
(12) Patent Application Publication
(10) Pub. No.: US 2025/0341656 A1
(43) Pub. Date: Nov. 6, 2025

(54) HUYGENS METALENS

(71) Applicant: THE ADMINISTRATORS OF THE TULANE EDUCATIONAL FUND, New Orleans, LA (US)

(72) Inventors: Matthew David ESCARRA, New Orleans, LA (US); Siddharth PADMANABHA, New Orleans, LA (US)

(21) Appl. No.: 18/864,706

(22) PCT Filed: May 11, 2023
(86) PCT No.: PCT/US2023/021950

§ 371 Date: Nov. 11, 2024

Related U.S. Application Data
(60) Provisional application No. 63/340,660, filed on May 11, 2022.
(60) Provisional application No. 63/458,972, filed on Apr. 13, 2023.

(51) Int. Cl. G02B 3/00; G02B 1/00

(52) U.S. Cl. CPC G02B 3/0056; G02B 1/005

(57) ABSTRACT

A metalens includes a substrate having a first pixel and a second pixel thereon. The first pixel includes a first periodic array of first antennae each having a first width, a first height, a first electric-dipole resonance, and a first magnetic-dipole resonance. The second pixel includes a second periodic array of second antennae each having a second width and a second height, a second electric-dipole resonance, and a second magnetic-dipole resonance. The first and second periodic arrays have a first period and a second period, respectively. At least one of (i) the first and second widths, (ii) the first and second heights are unequal, and (iii) the first and second periods, are unequal. For each resonance, the center wavelengths of the resonance differs from a design wavelength of the metalens, at which the metalens operates, by less than four times a linewidth of the resonance.

### CROSS-REFERENCE TO RELATED APPLICATIONS

This application claims the benefit of U.S. Provisional Application Nos. 63/340,660 and 63/458,972, filed on 11 May 2022 and 13 Apr. 2023, respectively, the disclosure of each is incorporated herein by reference in its entirety.

### GOVERNMENT RIGHTS

This invention was made with government support under DMR1727000, and DMR1654765 awarded by the National Science Foundation. The government has certain rights in the invention.

### FIELD OF THE INVENTION

The present invention relates to reconfigurable photonic devices and more particularly to such devices using phase change material-based low-loss Huygens metasurfaces.

### BACKGROUND

The increasing complexity of devices that function based on the manipulation of light has increased demand for an improvement in efficiency and a reduction in size and relative cost of individual components. In recent years, near two-dimensional (2D) photonic devices capable of imparting abrupt changes to impinging light waves have emerged. These devices, made up of arrays of sub-wavelength scatterers, impart abrupt phase shifts, amplitude modulation, polarizations shifts or spectral shifts.

Nanoscale photonic devices which impart abrupt and discretized phase delays provide significant benefits in size, weight and cost as compared to their traditional bulky counterparts. Dynamic and active reconfigurability of these devices would further improve these benefits, resulting in their use in a host of applications including but not limited to holograms, lenses, beam steerers, and optical modulators. It would therefore be desirable to have highly efficient, dynamically reconfigurable optical metasurface devices using phase change materials.

### SUMMARY OF THE EMBODIMENTS

In one aspect, a Huygens metalens includes a substrate having a first pixel and a second pixel thereon. The first pixel includes a first periodic array of first antennae each having a first width, a first height, a first electric-dipole resonance, and a first magnetic-dipole resonance. The first periodic array has a first period. The second pixel includes a second periodic array of second antennae each having a second width and a second height, a second electric-dipole resonance, and a second magnetic-dipole resonance. The second periodic array has a second period, at least one of (i) the first and the second widths are unequal, (ii) the first and the second heights are unequal, and (iii) the first and the second periods are unequal. A center wavelength of the first electric-dipole resonance differs from a design wavelength of the metalens, at which the metalens operates, by less than four times a linewidth of the first electric-dipole resonance. A center wavelength of the first magnetic-dipole resonance differs from the design wavelength by less than four times a linewidth of the first magnetic-dipole resonance. A center wavelength of the second electric-dipole resonance differs from the design wavelength by less than four times a linewidth of the second electric-dipole resonance. A center wavelength of the second magnetic-dipole resonance differs from the design wavelength by less than four times a linewidth of the second magnetic-dipole resonance.

### BRIEF DESCRIPTION OF THE FIGURES

FIG. 1 is a schematic of a pixel that includes a plurality of antenna elements arrayed on a substrate, in an embodiment.

FIGS. 2 and 3 are representative heatmap plots of computed phase of embodiments of the pixel of FIG. 1 as a function of pixel pitch and antenna element size for amorphous Sb₂S₃ and crystalline Sb₂S₃, respectively

FIG. 4 is a schematic of a metalens with two pixels and associated phase profiles, in an embodiment.

FIG. 5 is a schematic cross-sectional view of a metalens, which is an embodiment of the metalens of FIG. 4.

FIGS. 6 and 7 are plan views of respective metalenses that have the cross-sectional view of the metalens of FIG. 5.

FIG. 8 is a plot of an ideal phase profile for a cylindrical lens having 5-cm focal length and a four-level discretized phase profile of a PCM metalens in its crystalline state, in an embodiment.

FIG. 9 is a plot of an ideal phase profiles for a cylindrical lens having 3.5-cm focal lengths and a four-level discretized phase profile of the PCM metalens of FIG. 8 in its amorphous state, in an embodiment.

### DETAILED DESCRIPTION OF THE EMBODIMENTS

### Introduction

Embodiments herein include two dimensional photonic devices that include an array of scatterers based upon the Huygens-Fresnel principle, where each scatterer, or array of scatterers, acts as a Huygens' source and locally influences the wavelets of electromagnetic radiation. Each scatterer (hereafter called a nano-antenna or antenna element) operates as a point electric dipole which operates at the magnetic resonance of the material. By simultaneously controlling the electric and magnetic field dipole resonances within each nano-antenna it is possible to achieve full control of wavefronts.

For example, spectrally overlapping resonances lead to a full 21 radian phase shift of incident light leading to a suppression of reflection, and the design of highly transmissive metasurfaces. Alternatively, spectrally adjacent resonances may be tuned to achieve highly reflective metasurfaces with a complete suppression of transmitted wavefronts. Individual elements of nano-antenna geometry and metasurface periodicity may be tuned to separately affect spectral shifts in magnetic and electric resonances to achieve this tunability. Previously, these metasurfaces have consisted of metallic nano-antennas which operate on the principle of surface plasmon resonances. Dielectric Huygens metasurfaces, as opposed to their metallic counterparts, tend to have much lower losses owing to lower absorption coefficients.

Once fabricated however, these resonances can be further tuned actively to create interesting devices. This active tuning can be achieved using a multitude of methods. To name a few: by mechanically modifying the periodicity of the antennas, by modifying the refractive index of the participating media (encapsulant, substrate or the nano-antennas themselves), or by changing the properties of the incident light i.e., polarization and wavelength. Embodiments disclosed herein provide the optical tunability provided by phase change materials, specifically antimony trisulfide (Sb₂S₃) for switchable photonic devices.

### Material Overview—Antimony Trisulfide (Sb₂S₃)

Phase change materials (PCM) are media that can exist in multiple meta-stable structural states. In general, each of these states has different optical properties which can be leveraged to create active photonic devices. PCMs aid in optical modulation when switched from their different volatile or non-volatile phases. PCMs exhibit remarkable modifications in their refractive indices when subject to external stimuli (optical, electrical, and thermal) and have successfully been used as tunable materials for color displays and more. PCMs provide distinct advantages over other tunable optical materials, namely ultrafast switching speeds (10-100 nanoseconds); high cyclability (up to 1015 cycles), good scalability (down to nm-scale sizes), and adaptability to complementary metal oxide semiconductor (CMOS) fabrication technologies. Once switched, these materials require no further energy to maintain the structural state. This allows for the devices to be designed with a programmed specific response in mind.

PCMs include germanium-antimony-telluride (Ge₂Sb₂Te₅ or GST), Sb₂S₃, and Ge-Sb-Se-Te (GSST). Advantages of Sb₂S₃ include its suitability for both electrical and laser tuned active photonics as well as its relatively low switching energy density and a large Δn at wavelengths of interest. Sb₂S₃ exists in a metastable amorphous state and a stable crystalline state separated by a 2-eV energetic barrier. This barrier prevents the amorphous state from spontaneously crystallizing at room temperature and vice-versa. Crystallization can be achieved by heating the material to temperatures higher than 573K, while amorphization is achieved by heating above the melting temperature of 801K and rapidly quenching. This rapid quenching does not allow the structure to relax into the stable crystalline state, and freezes the material into the disorganized, amorphous state. Switching between these states has been demonstrated by optical and electrical methods. With switching times as low as 81 ns, Sb₂S₃ holds the potential for high efficiency, ultrafast photonic modulation. Switching between the two states results in a large shift (e.g., Δn≈1.1) in the refractive index of the material.

### Design Overview

Metasurfaces in the present disclosure are composed of individual Huygens source nano-antennas in a periodic array. Each metasurface was modeled as a periodic array of cylinders in a square lattice. In certain embodiments, such arrays are pixelated arrays of nano-antennas. In certain embodiments, such pixelated arrays of nano-antennas utilize discrete pixels to approximate a curve. The optical responses of these metasurfaces were modeled using Finite Element Method with the aid of COMSOL Multiphysics software.

By tuning the geometric parameters of the nano-antenna cylinders, namely the diameter and height, as well as the inter-element spacing within the periodic array, separately tunable electric and magnetic resonances were created. Each geometric parameter affects the spectral location of electric or magnetic resonance differently. While the location of the magnetic resonance is affected more by the height of the nano-antennas, the electric resonance is more sensitive to changes in the diameter. The edge-edge spacing has a similar effect on both resonances and can be used to tune the spectral location of the resonances to desired wavelengths. Although the presented trends are based on silicon nano-antenna arrays, the same principles apply to all transmissive dielectric metasurfaces.

Each resonance impinges a π radians phase shift in its spectral vicinity and overlap of both resonances impinges a 2π radians phase shift, thereby exhibiting the complete control of light. The interplay of both resonances was used to create phased arrays. Simultaneously controlling these resonances, along with the switching properties of PCMs, allowed for the creation of actively tunable/switchable photonic devices.

### Fabrication overview

Sb₂S₃ thin films were sputtered in an RF magnetron sputtering system, using ion sputtering with in situ substrate heating. Parameters used were 25 C deposition temperature, 3mT deposition pressure, 15 mW power at a rate of 0.24 nm/min. Low power and deposition rate were utilized to prevent cracking of the insulating target. Raman spectroscopy was also carried out on thermally crystallized films and the peaks match with the accepted literature values. As-deposited amorphous films are insulating and therefore require charge dissipation layers before electron beam lithography can be carried out.

### Amplitude and Phase Modulation using Sb₂S₃ Metasurfaces

In certain embodiments, the present invention provides an actively tunable amplitude and phase modulator made from Sb₂S₃ metasurfaces.

The geometry of Huygens sources as low aspect ratio Sb₂S₃ nano-antennas in a periodic arrangement was optimized to create spectrally overlapping resonant metasurfaces for near IR wavelengths in the crystalline phase (λ=780 nm). An encapsulating layer of PDMS was used to protect the metasurfaces from physical damage while creating an index match with the antennas' fused-silica substrate. These metasurfaces, when switched from the crystalline to the amorphous phase, displayed a resonance blue shift of about 100 nm. This resonance shift resulted in a phase modulation of ˜310 degrees at a minimal amplitude modulation of ˜0.5 dB at λ₀=720 nm, while amplitude modulation of ˜15 dB at a phase shift of ˜100 degrees was observed at λ₀=620 nm.

Similar designs were optimized for spectrally adjacent resonances with a spectral peak separation of ˜80 nm between the electric and magnetic field resonant peaks. Switching these metasurfaces resulted in a resonance peak shift of 150 nm for the B field peak and 90 nm for the E field peak. These resonance shifts resulted in a phase modulation of ˜265 degrees with minimal amplitude modulation of ˜0.14 dB at λ₀=950 nm.

### Reconfigurable Metalenses Based on Antimony Trisulfide (Sb₂S₃)

Dynamically reconfigurable optics based on phase change materials (PCMs) like Sb₂S₃ provide the opportunity for the design of lightweight and space efficient devices. Two-dimensional reconfigurable metalenses made of PCMs such as Sb₂S₃ provide size and weight benefits as compared to traditionally bulky dynamically reconfigurable lenses. As opposed to the traditional lenses, which provide a gradual accumulation of phase across interfaces, these metalenses provide abrupt phase shifts. Previous iterations of metalenses have used a full wave electromagnetic simulations of the entire metasurface array to create the desired phase shift and are computationally expensive. In embodiments, metalens geometries are chosen according to a figure of merit (FOM), that rewards both high transmission and proximity to transmitted phase to a target transmitted phase.

Equation (1) is one such merit function for a pixel 100. In equation (1), φₘₛ is a simulated metasurface phase shift and φ_{target} is target discretized phase. T is the average transmittance of pixel 100. Each of these quantities may be computed numerically with an electromagnetic field solver.

$$F O M = {T [ sin ( 2 ( {φ}_{ms} - {φ}_{target} ) ) / ( 2 ( {φ}_{ms} - {φ}_{target} ) ) ]}^{2} \qquad ( 1 )$$

Equations (2)-(4) show on such merit function for a pixel that includes antenna elements formed of a PCM. FOMₐ and FOM_{c} are respective figures of merit for the amorphous phase and crystalline phase. A metalens geometry may be jointly optimized using FOM_{eff} of equation (4). In equation (2), φ_{ms,a} is a simulated metasurface phase shift and φ_{target,a} is target discretized phase. In equation (3), φ_{ms,c} is a simulated metasurface phase shift and φ_{target,c} is target discretized phase. Tₐ and T_{c} refers to the average transmittance of the simulated array in the amorphous phase and crystalline phase, respectively.

$$F O {M}_{a} = {{T}_{a} [ sin ( 2 ( {φ}_{ms , a} - {φ}_{target , a} ) ) / ( 2 ( {φ}_{ms , a} - {φ}_{target , a} ) ) ]}^{2} \qquad ( 2 )$$

$$F O {M}_{c} = {{T}_{c} [ sin ( 2 ( {φ}_{ms , c} - {φ}_{target , c} ) ) / ( 2 ( {φ}_{ms , c} - {φ}_{target , c} ) ) ]}^{2} \qquad ( 3 )$$

$$F O {M}_{eff} = \sqrt{F O {M}_{a} \cdot F O {M}_{c}} \qquad ( 4 )$$

Figures herein depict orthogonal axes A1, A2, and A3, also referred to as the x axis, y axis, and z axis, respectively. Herein, the x-y plane is formed by orthogonal axes A1 and A2, and planes parallel to the x-y plane are referred to as transverse planes. Unless otherwise specified, heights and depths of objects herein refer to the object's extent along axis A3. Also, herein, a horizontal plane is parallel to the x-y plane, a width refers to an object's extent along the x or y axis respectively, and a vertical direction is along the z axis.

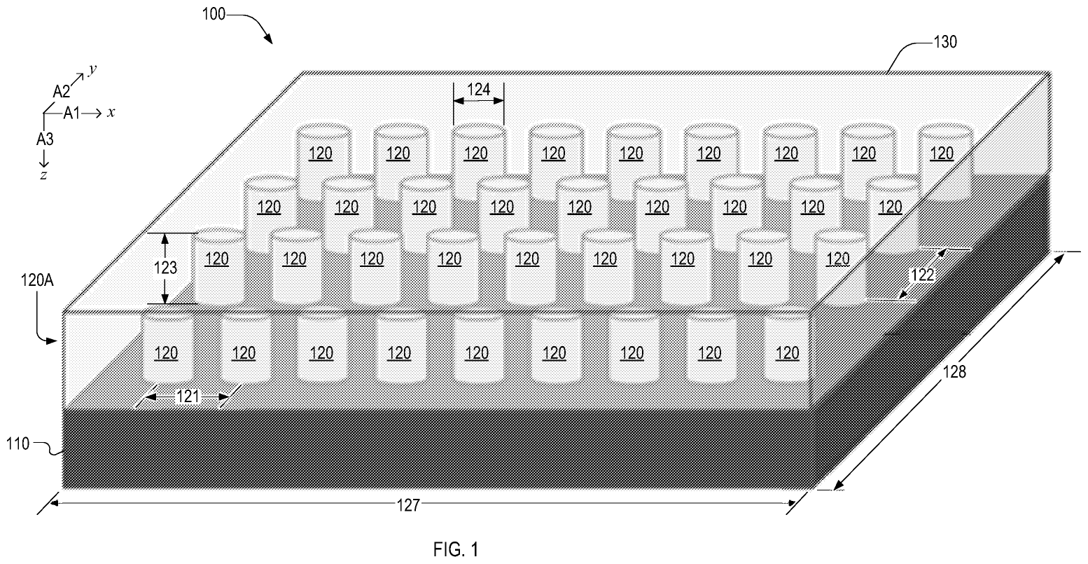

FIG. 1 is a schematic of a pixel 100. Pixel 100 includes a plurality of antenna elements 120 arrayed on a top surface of a substrate 110. Pixel 100 may also include on top surface 119, an encapsulant layer 130 that protects antenna elements 120. Encapsulant layer 130 may be formed of PDMS.

Substrate 110 may be a dielectric, such as fused silica, that is transparent to at least one of ultraviolet, visible, and near-infrared light at a design wavelength. Each antenna element 120 may be formed of a dielectric, such as silicon, silicon nitride, or silicon dioxide. In embodiments, each antenna element 120 is formed of a phase-change material (PCM), such as antimony trisulfide (Sb₂S₃), antimony triselenide, Ge₂Sb₂Te₅, and Ge-Sb-Se-Te. In embodiments, each antenna element is formed of, or includes, a phase-transition material, such as an oxide of vanadium, e.g., vanadium dioxide.

Antenna element 120 may be a unform-width pillar having circular or polygonal horizontal cross-section. When the cross-section is circular, antenna element 120 is cylindrical. The shape of the polygonal horizontal cross-section may be a convex polygon, such as a regular polygon with an integer number of edges greater than or equal to three.

Each antenna element 120 has an electric-dipole resonance and a magnetic-dipole resonance. In embodiments, these resonances overlap in a spectral region that includes a design wavelength of a metalens that includes pixel 100. Herein, λ₀ denotes the design wavelength in free space. The overlap of electric and magnetic-dipole resonances means that antenna element 120 satisfies the Kerker condition at the design wavelength, such that backward scattering is minimized or eliminated. Hence, in embodiments, light incident on pixel 100 excites both the electric and magnetic-dipole resonances of antenna element 120, and results inforward scattering that greatly exceeds backward scattering in magnitude.

In embodiments, antenna element 120 satisfies one or both of the following conditions, herein after the linewidth conditions: (i) a center wavelength of the electric-dipole resonance differs from the design wavelength by less than N times a linewidth of the electric-dipole resonance, and (ii) a center wavelength of the magnetic-dipole resonance differs from the design wavelength by less than N times a linewidth of the magnetic-dipole resonance. N may be equal to four. The linewidth may be a full-width half-max linewidth or a 1/e² linewidth.

When antenna element 120 is formed of a PCM its electric-dipole resonance and a magnetic-dipole resonance depends on whether the PCM is in its amorphous phase or in its crystalline phase. In such embodiments, antenna element 120 has: an amorphous electric-dipole resonance, an amorphous magnetic-dipole resonance, a crystalline electric-dipole resonance, a crystalline magnetic-dipole resonance. In embodiments, antenna element 120 is formed of a PCM and satisfies one or both of the aforementioned linewidth conditions in one or both of its amorphous phase and its crystalline phase.

Antenna elements 120 are arranged in a periodic two-dimensional array 120A in a horizontal plane. Array 120A is an Nₓ by N_{y} array, where Nₓ and N_{y} are positive integers. While Nₓ=9 and N_{y}=4 in FIG. 1, N₂ and N_{y} may equal other integers without departing from the scope hereof. Array 120A may be a rectangular array (as shown in FIG. 1), a square array, or a hexagonal array. In embodiments, array 120A has n-fold rotational symmetry such that a metalens that includes pixel 100 imparts the same phase shift to normally incident light (propagating along the z axis) that is polarized light in either the x-z plane or the y-z plane. In embodiments, n is greater than or equal to three.

In response to a plane wave incident thereon at the design wavelength, pixel 100 imposes a phase delay φₘₛ on the plane wave. Herein, and unless otherwise specified, a phase delay or phase shift refers to the modulo 2π value of the phase delay or phase shift imparted by an antenna element 120. Also herein, phase shift and phase delay are used interchangeably.

Array 120A has a period 121 along axis A1 and a period 122 along axis A2. Period 122 may equal period 121. Along respective axis A1 and A2, pixel 100 has a pixel-length 127 and a pixel-width 128, which equal the product of Nₓ and period 121 and the product of N_{y} and period 122. Antenna element 120 has a height 123 in the vertical direction and a width 124 in a horizontal plane. Periods 121 and 122, height 123, and width 124 define a parameter space in which specific combinations of these parameters yield both high transmission and low phase error, where phase error is the difference between the phase delay φ_{ms,a} and a target phase delay φ_{target}. A merit function such as that of equation (1) may be used to balance trade-offs between high transmission and low phase error. Each of Nₓ and N_{y} may equal or exceed eight to ensure a predictable phase delay, e.g., a phase delay with small standard deviation across the pixel.

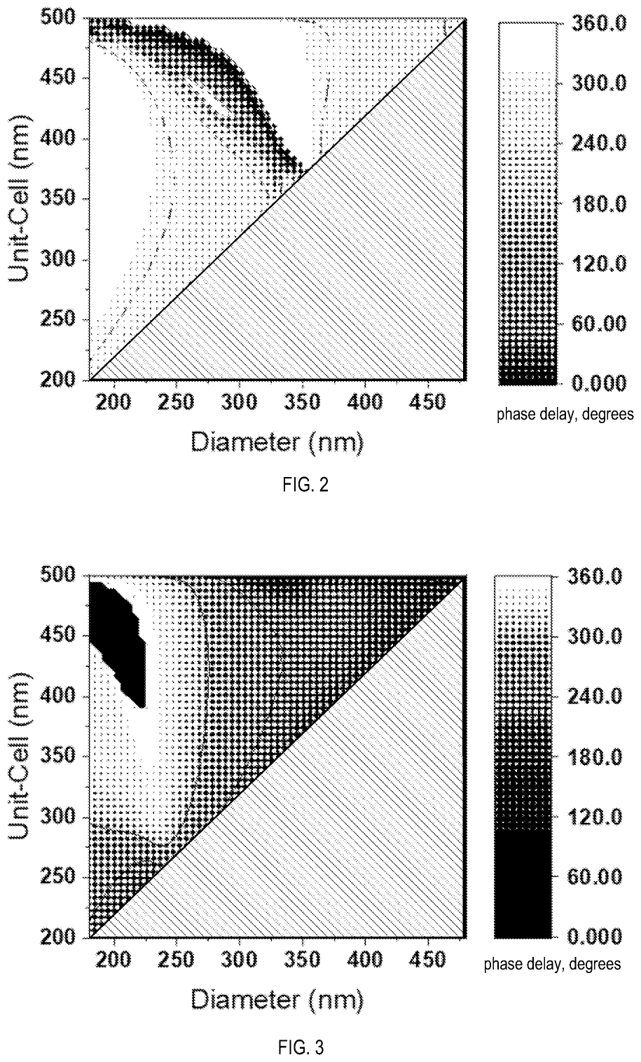

FIGS. 2 and 3 are heatmap plots illustrating part of the above-mentioned parameter space. Specifically, FIGS. 2 and 3 show metasurface phase as a function of width 124 and period 121 for an embodiment of pixel 100, as computed by a full-wave electromagnetic finite-element simulations. In this embodiments, substrate 110 is fused silica, periods 121 and 122 are equal, and encapsulant layer 130 is formed of PDMS. The design wavelength is 730 nm. Each antenna element 120 is cylindrical and formed of antimony trisulfide. FIGS. 2 and 3 correspond to the amorphous phase and crystalline phase, respectively. The finite-element simulations reveals the Kerker condition is satisfied in the amorphous phase when periods 121 and 122 equal 380 nm, height 123 is 160 nm, and width 124 is 320 nm.

More generally, embodiments of pixel 100 satisfy the Kerker condition and/or yield an optimal or near optimal figure of merit (such as those of equations (1) or (2)-(4)) when certain geometric conditions are satisfied. A first condition, herein after condition (a), as that ratio of height 123 to width 124 is less than or equal to two. Three conditions depend on the design wavelength λ₀ and the refractive index n of antenna element 120 at wavelength λ₀. These conditions are: (b) each of periods 121 and 122 is between 0.5λ₀/n and 2.5λ₀/n, (c) height 123 is between 0.4λ₀/n and 0.9λ₀/n, (d) width 124 is between 0.3λ₀/n and 1.5λₙ.), and (e) each of periods 121 and 122 is at least 40 nm greater than width 124. Pixel 100 may satisfy at least one of conditions (a), (b), (c), (d) and (e).

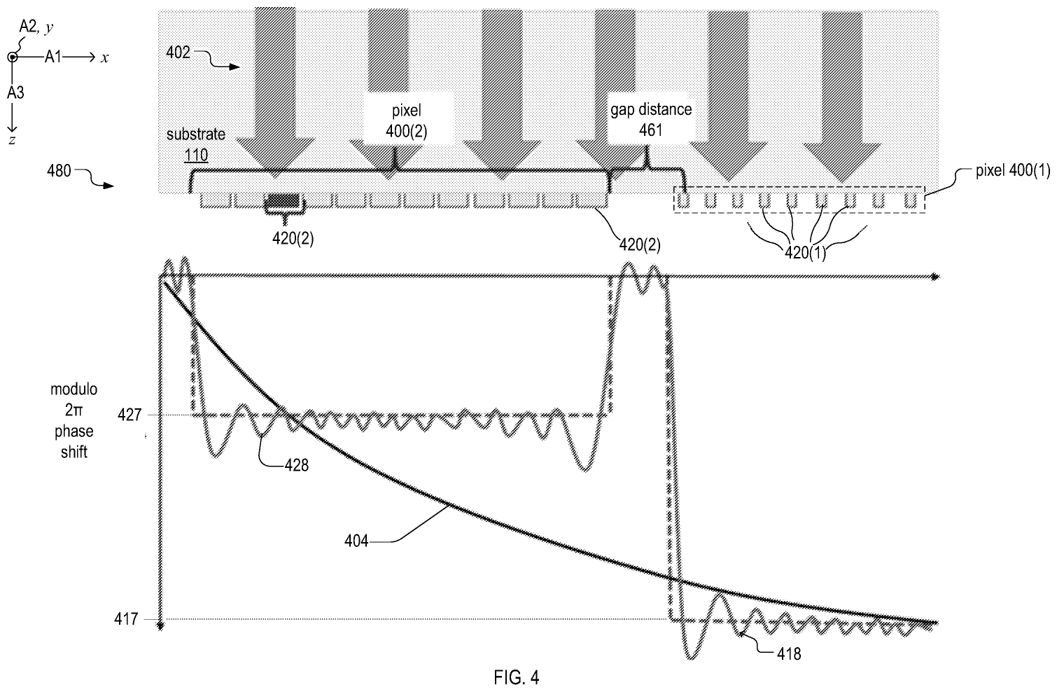

FIG. 4 is a cross-sectional schematic of a Huygens metalens 480 that includes pixels 400(1) and 400(2) on substrate 110. Pixels 400(1) and 400(2) are adjacent and separated by an inter-pixel distance 461. Each pixel 400(1,2) is an example of pixel 100, and include respective plurality of antenna elements 420(1) and 420(2), each of which are examples of antenna elements 120.

FIG. 4 also illustrates a plane wave 402 incident on metalens 480. Pixels 400(1) and 400(2) impose respective phase shifts 418 and 428 on plane wave 402. Phase shifts 418 and 428 are unequal, and each is an example of phase delay φₘₛ of equation (1). Pixels 400(1) and 400(2) are designed to match respective target phase shifts 417 and 427, shown as dashed lines in FIG. 4. FIG. 4 also illustrates a phase shift 404 of a conventional refractive cylindrical lens having the same focal length as metalens 480. Pixel 400(1) is closer to the center of this cylindrical lens, while pixel 400(2) is closer to an edge.

To reduce effects of coupling between adjacent pixels 400, inter-pixel distance 461 may be greater than or equal to design wavelength λ₀. Under aforementioned condition (b), the maximum value of design wavelength λ₀ is the product of refractive index n and the array periodicity, which is either period 121 or 122, depending on the direction of inter-pixel distance 461. In the example of FIG. 2, this inter-pixel distance 461 is along axis A1, such that minimum value of inter-pixel distance 461 may be expressed as two times the product of refractive index n and period 121. Along axis A1 and A2, respectively, inter-pixel distance 461 may be less than pixel-length 127 and pixel-width 128 respectively, such that the fill factor of metalens 480 is sufficient for it to function as a lens.

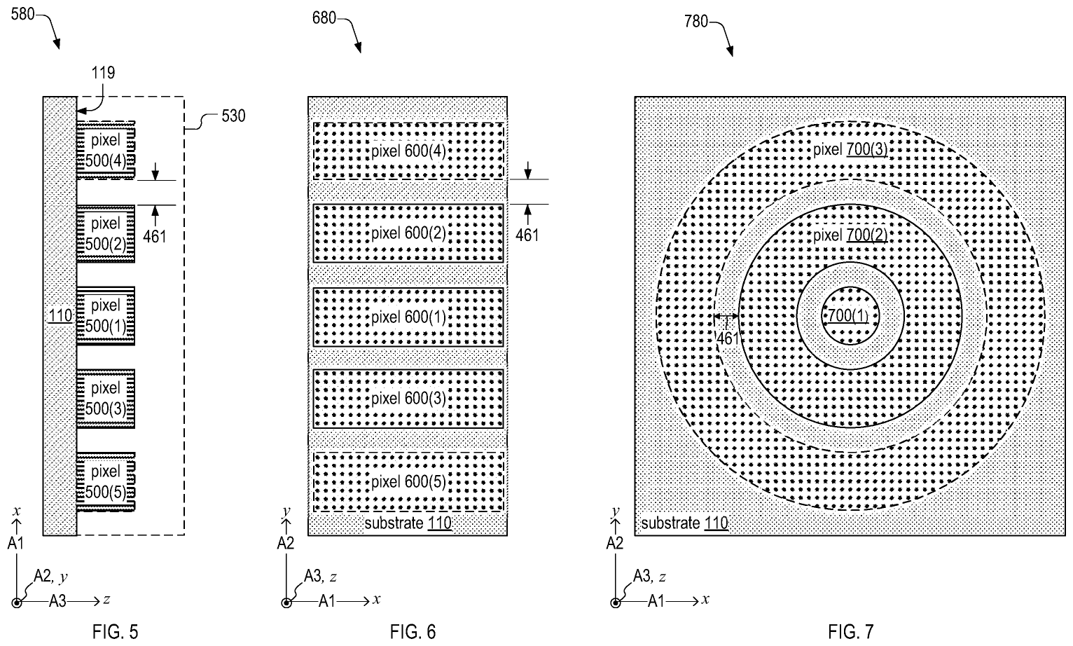

FIG. 5 is a schematic cross-sectional view of a Huygens metalens 580, which is an example of metalens 480. Metalens 580 includes pixels 500(1), 500(2), and 500(3) on a top surface 119 of substrate 110. Pixel 500(1) is between pixels 500(2) and 500(3). Metalens 580 may include additional pixels, such as pixels 500(4) and 500(5). Adjacent pixels 500 are separated by inter-pixel distance 461. Metalens 580 may also include an encapsulant layer 530, which is an example of encapsulant layer 130. In embodiments, an imaging system, e.g., of a camera includes one or more metalens 580. In other embodiments, a projector includes a projection-optics unit that includes one or more metalenses 580.

In response to a plane wave incident thereon at the design wavelength λ₀, pixels 500(1), 500(2), and 500(3) impose a respective first phase delay, a second phase delay, and a third phase delay on the plane wave. The third phase delay equals the second delay and differs from the first phase delay. Pixel 500(3) may be identical to pixel 500(2), e.g., in terms of material properties and geometric properties of their respective arrays 120A.

When metalens 580 includes pixels 500(4) and 500(5), these pixels impose a respective fourth phase delay and a fifth phase delay on the plane wave. The fourth delay equals the fifth delay and differs from each of the first, second, and third phase delays. Pixel 500(4) may be identical to pixel 500(5), e.g., in terms of material properties and geometric properties of their respective arrays 120A.

Metalens 580 may be a positive lens, in which case the first phase delay exceeds the second phase delay, and hence also exceeds the third phase delay. When metalens 580 includes pixels 500(4) and 500(5), the second and third phase delays exceed each of the fourth and fifth phase delays. The first, second, and third phase delays may best fit the parabolic phase profile of an ideal positive lens.

Metalens 580 may be a negative lens, in which case the first phase delay is less than the second phase delay, and hence also is less than the third phase delay. When metalens 580 includes pixels 500(4) and 500(5), the second and third phase delays are less than each of the fourth and fifth phase delays. The first, second, and third phase delays may best fit the parabolic phase profile of an ideal negative lens. In embodiments, metalens 580 does not include pixel 500(1), such that light propagating through this region experiences a no phase delay, and hence less phase delay than light propagating through pixels 500(k>1).

A metalens 580 is “single-band” at its design wavelength λ₀. A multi-band metalens includes a stack of N metalenses 580(1-N), where N≥2 and each metalens 580 has a respective design wavelength that differs from that of other metalenses 580. In the geometry of FIG. 5, this stack of metalenses 580 (1-N) extends along axis A3, and has a height that increases with increasing N. In embodiments, N=3, and the respective design wavelengths for the first, second, and third metalens 580 are in respective regions of the electromagnetic spectrum. Examples of such regions include those of the visible spectrum (e.g., red, green, and blue), and broader regions, such as ultraviolet, visible, and near-IR.

FIGS. 6 and 7 are plan views of respective Huygens metalenses 680 and 780, each of which is an example of metalens 580. Metalens 680 functions as a cylindrical lens and includes rectangular pixels 600(1-3), and may also include rectangular pixels 600(4) and 600(5). Pixel 600(k) is an example of pixel 500(k), where index k is a positive integer less than or equal to five.

Metalens 780 functions as a lens with rotational and/or axial symmetry, such as a spherical lens, and includes a center pixel 700(1) and at least an annular pixel 700(2). Pixels 700 of metalens 780 may be concentric. In a horizontal cross-section, antenna elements 120 of pixel 700(1) may occupy a circular region or a polygonal region. In this cross-section, antenna elements 120 of “off-axis” pixels 700(k≠1) occupy an annular region. Metalens 780 may also include a pixel 700(3). In a cross-sectional view of metalens 780 in the x-y plane, pixels 500(2) and 500(3) represent a cross-sectional view of annular pixel 700(2), and pixels 500(4) and 500(5) represent a cross-sectional view of annular pixel 700(3). FIG. 7 illustrates pixels 700 as having axial symmetry: pixel 700(1) is cylindrical, while annular pixels 700(2) and 700(3) are circular annuli. Without departing from the scope hereof, pixels 700 may have m-rotational symmetry about an axis parallel to axis A3, where m is greater than or equal to two. In such embodiments, the annular region occupied by “off-axis” pixels 700 (k≠1) is polygonal, e.g., a hexagonal annulus or an octagonal annulus. In embodiments, m is greater than or equal to four.

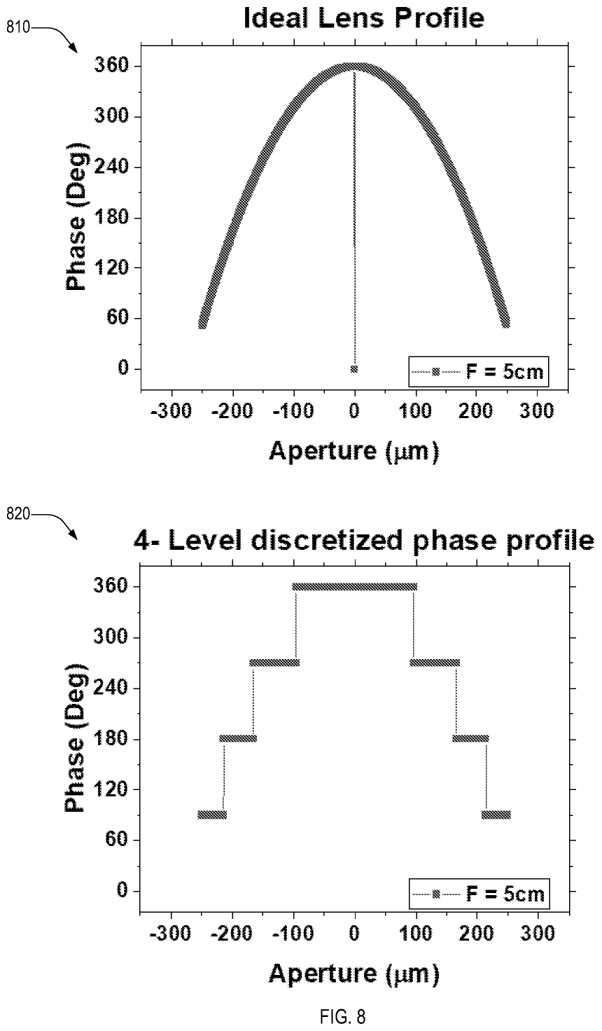

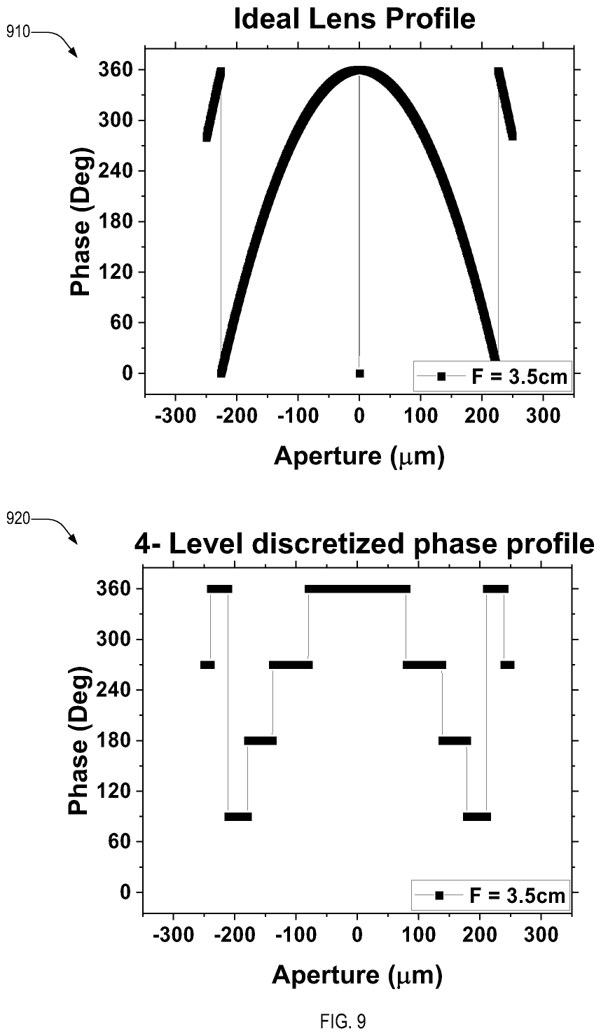

FIG. 8 depicts phase-profile plots 810 and 820. Plot 810 ideal phase profile for a cylindrical lens having 5-cm focal length. Plot 820 is a discretized phase profile of an antimony trisulfide metalens in its crystalline state. FIG. 9 depicts phase-profile plots 910 and 920. Plot 910 is an ideal phase profile of a cylindrical lens having 3.5-cm focal length. Plot 920 is a discretized phase profile of an antimony trisulfide metalens in its amorphous state.

### Combinations of Features

Features described above, as well as those claimed below, may be combined in various ways without departing from the scope hereof. The following enumerated examples illustrate some possible, non-limiting combinations.

(A1) A Huygens metalens includes a substrate having a first pixel and a second pixel thereon. The first pixel includes a first periodic array of first antennae each have a first width, a first height, a first electric-dipole resonance, and a first magnetic-dipole resonance. The first periodic array has a first period. The second pixel includes a second periodic array of second antennae each have a second width and a second height, a second electric-dipole resonance, and a second magnetic-dipole resonance. The second periodic array has a second period, at least one of (i) the first and the second widths are unequal, (ii) the first and the second heights are unequal, and (iii) the first and the second periods are unequal. center wavelength of the first electric-dipole resonance differs from a design wavelength of the metalens, at which the metalens operates, by less than four times a linewidth of the first electric-dipole resonance. A center wavelength of the first magnetic-dipole resonance differs from the design wavelength by less than four times a linewidth of the first magnetic-dipole resonance. A center wavelength of the second electric-dipole resonance differs from the design wavelength by less than four times a linewidth of the second electric-dipole resonance. A center wavelength of the second magnetic-dipole resonance differs from the design wavelength by less than four times a linewidth of the second magnetic-dipole resonance.

(A2) In embodiments of metalens (A1), in response to a plane wave incident thereon at the design wavelength, the first pixel and the second pixel impose a respective first phase delay and a second phase delay on the plane wave, the second phase delay differs from the first phase delay.

(A3) Embodiments of either of metalenses (A1) and (A2) further include a third pixel adjacent to the first pixel and on a side of the first pixel opposite the second pixel such that the first pixel is between the second pixel and the third pixel. The third pixel include a third periodic array of third antennae each have a third width and a third height, a third electric-dipole resonance, and a third magnetic-dipole resonance. The third periodic array has a third period. At least one of (i) the first and the third widths are unequal, (ii) the first and the third heights are unequal, and (iii) the first and the third periods are unequal. A center wavelength of the third electric-dipole resonance differs from the design wavelength by less than four times a linewidth of the third electric-dipole resonance. A center wavelength of the third magnetic-dipole resonance differs from the design wavelength by less than four times a linewidth of the third magnetic-dipole resonance.

(A4) In embodiments of metalens (A3), the third pixel is identical to the second pixel, such that: (i) the third width, the third height, and the third period equal the second width, the second height, and the second period, respectively, and (ii) the third electric-dipole resonance and the third magnetic-dipole resonance equal the second electric-dipole resonance and the second magnetic-dipole resonance, respectively.

(A5) In embodiments of any one of metalenses (A1)-(A4), in response to a plane wave incident thereon at the design wavelength, the first pixel, the second pixel, and the third pixel impose a respective first phase delay, a second phase delay, and a third phase delay on the plane wave, the third phase delay equaling the second delay and differs from the first phase delay.

(A6) In embodiments of metalens (A5), the first phase delay exceeds each of the second phase delay and the third phase delay.

(A7) In embodiments of metalens (A5), the first phase delay is less than each of the second phase delay and the third phase delay.

(A8) In embodiments of any one of metalenses (A1)-(A7), the first height is between 0.4λ₀/n₁ and 0.9λ₀/n₁, the second height is between 0.4λ₀/n₂ and 0.9λ₀/n₂, and where λ₀, n₁, and n₂ are, respectively, the design wavelength, the refractive index of the first antenna at the design wavelength, the refractive index of the second antenna at the design wavelength.

(A9) In embodiments of any one of metalenses (A1)-(A8), the first width is between 0.3λ₀/n₁ and 1.5λ₀/n₁, and the second width is between 0.3λ₀/n₂ and 1.5λ₀/n₂.

(A10) In embodiments of any one of metalenses (A1)-(A9), the first period is at least 40 nm greater than the first width, and the second period is at least 40 nm greater than the second width.

(A11) In embodiments of any one of metalenses (A1)-(A10), a ratio of first height to the first width is less than or equal to two, a ratio of second height to the second width is less or equal to than two.

(A12) In embodiments of any one of metalenses (A1)-(A11), the first pixel and the second pixel are separated by an inter-pixel distance that is greater than or equal to the design wavelength.

(A13) In embodiments of any one of metalenses (A1)-(A12), the first pixel and the second pixel are on a front surface of the substrate, the first periodic array and the second periodic array includes at least eight periods in each of a first direction parallel to the front surface and a second direction perpendicular to the first direction parallel to the front surface.

(A14) Embodiments of any one of metalenses (A1)-(A13) further include a fourth pixel and a fifth pixel. The fourth pixel is adjacent to the second pixel such that the second pixel is between the first pixel and the fourth pixel. The fifth pixel is adjacent to the third pixel such that the third pixel is between the first pixel and the fifth pixel. The fourth pixel includes a fourth periodic array of fourth antennae each having a fourth width and a fourth height, a fourth electric-dipole resonance, and a fourth magnetic-dipole resonance. The fourth periodic array has a fourth period. At least one of (i) the second and the fourth widths are unequal, (ii) the second and the fourth heights are unequal, and (iii) the second and the fourth periods are unequal. The fifth pixel includes a fifth periodic array of fifth antennae each having a fifth width and a fifth height, a fifth electric-dipole resonance, and a fifth magnetic-dipole resonance. The fifth periodic array has a fifth period. At least one of (i) the third and the fifth widths are unequal, (ii) the third and the fifth heights are unequal, and (iii) the third and the fifth periods are unequal. A center wavelength of the fourth electric-dipole resonance differs from the design wavelength by less than four times a linewidth of the fourth electric-dipole resonance. A center wavelength of the fifth magnetic-dipole resonance differs from the design wavelength by less than four times a linewidth of the fifth magnetic-dipole resonance. A center wavelength of the fifth electric-dipole resonance differs from the design wavelength by less than four times a linewidth of the fifth electric-dipole resonance. A center wavelength of the fifth magnetic-dipole resonance differs from the design wavelength by less than four times a linewidth of the fifth magnetic-dipole resonance.

(A15) Embodiments of any one of metalenses (A1)-(A14) further include an encapsulating layer on the substrate and encapsulating each of the first pixel and the second pixel, and any additional pixels of the metalens.

(A16) In embodiments of any one of metalenses (A1)-(A15), a center wavelength of the first electric-dipole resonance differs from the design wavelength by less than four times a linewidth of the first electric-dipole resonance; a center wavelength of the first magnetic-dipole resonance differs from the design wavelength by less than four times a linewidth of the first magnetic-dipole resonance; a center wavelength of the second electric-dipole resonance differs from the design wavelength by less than four times a linewidth of the second electric-dipole resonance; and a center wavelength of the second magnetic-dipole resonance differs from the design wavelength by less than four times a linewidth of the second magnetic-dipole resonance.

(A17) In embodiments of any one of metalenses (A1)-(A16), each of the first and the second antennae is formed of a phase-change material having a crystalline refractive index and an amorphous refractive index. The first electric and the first magnetic-dipole resonance are respective electric and magnetic-dipole resonances of the first antenna in its amorphous phase. The second electric and the second magnetic-dipole resonance are respective electric and magnetic-dipole resonances of the second antenna in its amorphous phase. Each first antenna has, in its crystalline phase, a first-crystalline electric-dipole resonance and a first-crystalline magnetic-dipole resonance that differ from the first electric-dipole resonance and the first magnetic-dipole resonance, respectively. Each second antenna has, in its crystalline phase, a second-crystalline electric-dipole resonance and a second-crystalline magnetic-dipole resonance that differ from the second electric-dipole resonance and the second magnetic-dipole resonance, respectively.

(A18) In embodiments of any one of metalenses (A1)-(A17), in the metalens's amorphous phase and in response to a plane wave incident thereon at the design wavelength, the first pixel and the second pixel impose a respective first-amorphous phase delay and a second-amorphous phase delay on the plane wave. The second-amorphous phase delay differs from the first-amorphous phase delay. In the metalens's crystalline phase and in response to the plane wave incident thereon at the design wavelength, the first pixel and the second pixel impose a respective first-crystalline phase delay and a second-crystalline phase delay on the plane wave. The second-crystalline phase delay may differ from the first-crystalline phase delay. The first-crystalline phase delay may differ from the first-amorphous phase delay. The second-crystalline phase delay differs from the second-amorphous phase delay

(A19) In embodiments of either one of metalenses (A17) and (A18), the phase-change material is one of antimony trisulfide, antimony triselenide, Ge₂Sb₂Te₅, Ge-Sb-Se-Te, and an oxide of vanadium, or any combination thereof.

(A20) In embodiments of any one of metalenses (A1)-(A19), the first height and the second height is along an axial direction of the metalens, and each of the first pixel and second pixel has m-fold rotational symmetry about an axis perpendicular the axial direction, where m is an integer greater than or equal to two. In embodiments, m is greater than or equal to four.

(A21) A multiband metalens includes a first metalens and a second metalens, each of which is any one of metalenses (A1)-(20). The second metalens is stacked on the first metalens. The design wavelength λ₀ of the first metalens equals a first wavelength. The design wavelength λ₀ of the first metalens equals a second wavelength that differs from the first wavelength.

Changes may be made in the above methods and systems without departing from the scope of the present embodiments. It should thus be noted that the matter contained in the above description or shown in the accompanying drawings should be interpreted as illustrative and not in a limiting sense. Herein, and unless otherwise indicated the phrase “in embodiments” is equivalent to the phrase “in certain embodiments,” and does not refer to all embodiments. The following claims are intended to cover all generic and specific features described herein, as well as all statements of the scope of the present method and system, which, as a matter of language, might be said to fall therebetween.

We claim:

1. A Huygens metalens comprising:
a substrate having a first pixel and a second pixel thereon;
the first pixel including a first periodic array of first antennae each having a first width, a first height, a first electric-dipole resonance, and a first magnetic-dipole resonance, the first periodic array having a first period;
the second pixel including a second periodic array of second antennae each having a second width and a second height, a second electric-dipole resonance, and a second magnetic-dipole resonance, the second periodic array having a second period, at least one of (i) the first and the second widths are unequal, (ii) the first and the second heights are unequal, and (iii) the first and the second periods are unequal;
a center wavelength of the first electric-dipole resonance differing from a design wavelength of the metalens, at which the metalens operates, by less than four times a linewidth of the first electric-dipole resonance;
a center wavelength of the first magnetic-dipole resonance differing from the design wavelength by less than four times a linewidth of the first magnetic-dipole resonance;
a center wavelength of the second electric-dipole resonance differing from the design wavelength by less than four times a linewidth of the second electric-dipole resonance; and
a center wavelength of the second magnetic-dipole resonance differing from the design wavelength by less than four times a linewidth of the second magnetic-dipole resonance.

2. The metalens of claim 1, wherein in response to a plane wave incident thereon at the design wavelength, the first pixel and the second pixel impose a respective first phase delay and a second phase delay on the plane wave, the second phase delay differing from the first phase delay.

3. The metalens of claim 2, further comprising:
a third pixel adjacent to the first pixel and on a side of the first pixel opposite the second pixel such that the first pixel is between the second pixel and the third pixel;
the third pixel including a third periodic array of third antennae each having a third width and a third height, a third electric-dipole resonance, and a third magnetic-dipole resonance, the third periodic array having a third period, at least one of (i) the first and the third widths are unequal, (ii) the first and the third heights are unequal, and (iii) the first and the third periods are unequal; and
a center wavelength of the third electric-dipole resonance differing from the design wavelength by less than four times a linewidth of the third electric-dipole resonance;
a center wavelength of the third magnetic-dipole resonance differing from the design wavelength by less than four times a linewidth of the third magnetic-dipole resonance.

4. The metalens of claim 3, the third pixel being identical to the second pixel, such that: (i) the third width, the third height, and the third period equal the second width, the second height, and the second period, respectively, and (ii) the third electric-dipole resonance and the third magnetic-dipole resonance equal the second electric-dipole resonance and the second magnetic-dipole resonance, respectively.

5. The metalens of claim 3, wherein in response to a plane wave incident thereon at the design wavelength, the first pixel, the second pixel, and the third pixel impose a respective first phase delay, a second phase delay, and a third phase delay on the plane wave, the third phase delay equaling the second delay and differing from the first phase delay.

6. The metalens of claim 5, the first phase delay exceeding each of the second phase delay and the third phase delay.

7. The metalens of claim 5, the first phase delay being less than each of the second phase delay and the third phase delay.

8. The metalens of claim 3, further comprising:
a fourth pixel adjacent to the second pixel such that the second pixel is between the first pixel and the fourth pixel; and
a fifth pixel adjacent to the third pixel such that the third pixel is between the first pixel and the fifth pixel;
the fourth pixel including a fourth periodic array of fourth antennae each having a fourth width and a fourth height, a fourth electric-dipole resonance, and a fourth magnetic-dipole resonance, the fourth periodic array having a fourth period, at least one of (i) the second and the fourth widths are unequal, (ii) the second and the fourth heights are unequal, and (iii) the second and the fourth periods are unequal;
the fifth pixel including a fifth periodic array of fifth antennae each having a fifth width and a fifth height, a fifth electric-dipole resonance, and a fifth magnetic-dipole resonance, the fifth periodic array having a fifth period, at least one of (i) the third and the fifth widths are unequal, (ii) the third and the fifth heights are unequal, and (iii) the third and the fifth periods are unequal; and
a center wavelength of the fourth electric-dipole resonance differing from the design wavelength by less than four times a linewidth of the fourth electric-dipole resonance;
a center wavelength of the fifth magnetic-dipole resonance differing from the design wavelength by less than four times a linewidth of the fifth magnetic-dipole resonance;
a center wavelength of the fifth electric-dipole resonance differing from the design wavelength by less than four times a linewidth of the fifth electric-dipole resonance;
a center wavelength of the fifth magnetic-dipole resonance differing from the design wavelength by less than four times a linewidth of the fifth magnetic-dipole resonance.

9. The metalens of claim 1,
the first height being between 0.4λ₀/n₁ and 0.9λ₀/n₁,
the second height being between 0.4λ₀/n₂ and 0.9λ₀/n₂, and
where λ₀, n₁, and n₂ are, respectively, the design wavelength, the refractive index of the first antenna at the design wavelength, the refractive index of the second antenna at the design wavelength.

10. The metalens of claim 1,
the first width being between 0.3λ₀/n₁ and 1.5λ₀/n₁,
the second width being between 0.3λ₀/n₂ and 1.5λ₀/n₂, and
where λ₀, n₁, and n₂ are, respectively, the design wavelength, the refractive index of the first antenna at the design wavelength, the refractive index of the second antenna at the design wavelength.

11. The metalens of claim 1,
the first period being at least 40 nm greater than the first width and,
the second period being at least 40 nm greater than the second width.

12. The metalens of claim 1, a ratio of first height to the first width being less than two, and a ratio of second height to the second width being less than two.

13. The metalens of claim 1, the first pixel and the second pixel being separated by an inter-pixel distance that is greater than or equal to the design wavelength.

14. The metalens of claim 1, the first pixel and the second pixel being on a front surface of the substrate, the first periodic array and the second periodic array including at least eight periods in each of a first direction parallel to the front surface and a second direction perpendicular to the first direction parallel to the front surface.

15. The metalens of claim 1, the first height and the second height being along an axial direction of the metalens, each of the first pixel and second pixel having m-fold rotational symmetry about an axis perpendicular the axial direction, where m is an integer greater than or equal to two.

16. The metalens of claim 1, further comprising an encapsulating layer on the substrate and encapsulating each of the first pixel and the second pixel.

17. The metalens of claim 1,
each of the first and the second antennae being formed of a phase-change material having a crystalline refractive index and an amorphous refractive index, the first electric and the first magnetic-dipole resonance being respective electric and magnetic-dipole resonances of the first antenna in its amorphous phase, the second electric and the second magnetic-dipole resonance being respective electric and magnetic-dipole resonances of the second antenna in its amorphous phase,
each first antenna having, in its crystalline phase, a first-crystalline electric-dipole resonance and a first-crystalline magnetic-dipole resonance that differ from the first electric-dipole resonance and the first magnetic-dipole resonance, respectively; and
each second antenna having, in its crystalline phase, a second-crystalline electric-dipole resonance and a second-crystalline magnetic-dipole resonance that differ from the second electric-dipole resonance and the second magnetic-dipole resonance, respectively.

18. The metalens of claim 17, wherein:
in the metalens's amorphous phase and in response to a plane wave incident thereon at the design wavelength, the first pixel and the second pixel impose a respective first-amorphous phase delay and a second-amorphous phase delay on the plane wave, the second-amorphous phase delay differing from the first-amorphous phase delay; and
in the metalens's crystalline phase and in response to the plane wave incident thereon at the design wavelength, the first pixel and the second pixel impose a respective first-crystalline phase delay and a second-crystalline phase delay on the plane wave, the second-crystalline phase delay differing from the first-crystalline phase delay
the first-crystalline phase delay differs from the first-amorphous phase delay, and
the second-crystalline phase delay differs from the second-amorphous phase delay.

19. The metalens of claim 17, the phase-change material being one of antimony trisulfide, antimony triselenide, Ge₂Sb₂Te₅, Ge-Sb-Se-Te, and an oxide of vanadium.

20. A multiband metalens comprising:
a first metalens of claim 1, its design wavelength λ₀ equaling a first wavelength; and
a second metalens of claim 1 stacked on the first metalens of claim 1, its design wavelength λ₀ equaling a second wavelength that differs from the first wavelength.
